(19) United States
(12) Patent Application Publication
(10) Pub. No.: US 2006/0061139 A1
(43) Pub. Date: Mar. 23, 2006

(54) Vehicle lamp and method for manufacturing vehicle lamp

(75) Inventor: Mitsuyuki Mochizuki, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD.

(21) Appl. No.: 11/227,169

(22) Filed: Sep. 16, 2005

(30) Foreign Application Priority Data
Sep. 17, 2004 (JP) P.2004-271310

(51) Int. Cl. B60J 7/00

(52) U.S. Cl. 296/201

(57) ABSTRACT

A vehicle lamp is manufactured by laying a metal wire on a resin sheet by way of thermally wiring, and injection molding a lens with the resin sheet inserted in a mold.

The present application claims foreign priority based on Japanese Patent Application No. P.2004-271310, filed on Sep. 17, 2004, the contents of which are incorporated herein by reference.

### BACKGROUND OF THE INVENTION

1. Field of the Invention

The present invention relates to a vehicle lamp and a manufacturing method of the vehicle lamp. More particularly, the present invention relates to a method to manufacturing a vehicle lamp with a lens including a heater for removing fog or melting a snow, at a low cost, as well as reducing an adverse effect on light distribution.

2. Related Art

There is a method for melting snow sticking to a lens of a vehicle lamp and removing fog on the lens, by applying current in a metal wire laid on the lens.

However, it is difficult to fix the metal wire at a desired position on the lens. Another problem is an adverse effect of the metal wire on light distribution.

### SUMMARY OF THE INVENTION

In accordance with one or more embodiments of the present invention, it is possible to manufacture a vehicle lamp equipped with a heater for removing fog and melting snow at a low cost and to reduce an effect on light distribution.

In accordance with one or more embodiments of the present invention, a method for manufacturing a vehicle lamp is provided with: thermally wiring a metal wire on a resin sheet; and injection molding a lens with the resin sheet inserted in a mold.

Thus, the vehicle lamp equipped with a lens can be manufactured at a low cost and with reduced effect on light distribution.

Since the metal wire is laid on a flat resin sheet through heat wiring, instead of a lens having three-dimensional profile. Therefore, it is easy to lay a metal wire in a desired pattern at a low cost.

In accordance with one or more embodiments of the present invention, the thermally wiring is preformed by applying an ultrasonic vibration so as to heat and melt the resin sheet and embed the metal wire partially into the resin sheet. This simplifies a facility for thermally wiring and reduces work time.

In accordance with one or more embodiments of the present invention, the resin sheet is shaped into a predetermined profile before the resin sheet is inserted into the mold. This facilitates insertion of the resin sheet into the mold in the process of molding.

In accordance with one or more embodiments of the present invention, a terminal is fixed on the resin sheet, and the metal wire is connected to the terminal. This facilitates connection with a power source for feeding power to the metal wire.

In accordance with one or more embodiments of the present invention, the metal wire is positioned so as to stride over the terminal, and the terminal and the metal wire striding over the terminal are connected by welding. This facilitates connection of the metal wire and the terminal.

In accordance with one or more embodiments of the present invention, the resin sheet is inserted into the mold so that a surface on which the metal wire is laid is faced to a resin to be injected. This prevents drop of the metal wire from the lens. Moreover, the metal wire does not come into contact with air. This avoids degradation caused by oxidation, fading and change in a resistance value. The face of the resin sheet on which the metal wire is laid is covered by a resin for a lens. Thus, irregular reflection or irregular deflection around the metal wire is eliminated or reduced, thus removing the visibility.

In accordance with one or more embodiments of the present invention, a vehicle lamp made by a process including: thermally wiring a metal wire on a resin sheet; and injection molding a lens with the resin sheet inserted in a mold.

In accordance with one or more embodiments of the present invention, a vehicle lamp is provided with: a resin sheet; a lens integrally formed on the resin sheet; and a metal wire partially embedded into the resin sheet and disposed between the resin sheet and the lens.

In accordance with one or more embodiments of the present invention, the metal wire is used as a heater.

In accordance with one or more embodiments of the present invention, the vehicle lamp is further provided with a bank-shaped prominence on the resin sheet at a position on a side of the metal wire.

Other aspects and advantages of the invention will be apparent from the following description and the appended claims.

### BRIEF DESCRIPTION OF THE DRAWINGS

FIG. 1A shows a general vertical cross section of a vehicle lamp.

FIG. 1B is a general front view of the vehicle lamp.

FIG. 2A shows a simplified exemplary wiring head to perform wiring by using a metal wire in a standby state before wiring.

FIG. 2B shows the simplified exemplary wiring head while wiring is under way.

FIG. 2C shows the simplified exemplary wiring head in a state where wiring is complete.

FIG. 3 shows an exploded cross section of a section where the terminal of a resin sheet is mounted.

FIG. 4 shows an example of wiring pattern using a metal wire.

FIG. 5 is an exploded cross section of the main parts showing variations of connecting a metal wire to the terminal.

FIG. 6 is an exploded cross section of a metal wire partially embedded into a resin sheet by way of wiring.

FIG. 7A is a general cross section showing the outline of shaping before insert forming (before shaping).

FIG. 7B is a general cross section showing the outline of shaping before insert forming (after shaping).

FIG. 8A is a plan view of a main margin for preventing break of a metal wire under deformation of a resin sheet, in which the metal wire is formed into a waveform pattern.

FIG. 8B is a plan view of a main margin for preventing break of a metal wire under deformation of a resin sheet, in which the metal wire is formed into a zigzag pattern.

FIG. 8C is a plan view of a main margin in which the metal wire is floating from the resin sheet.

FIG. 9 shows a cross section of a post-shaping resin sheet inserted into a mold.

FIG. 10A is a front view of the appearance of the section where wiring is made using a metal wire, and a cross section thereof shown below, showing how the wiring-finished resin sheet will appear.

FIG. 10B is a front view of the appearance of the section where wiring is made using a metal wire, and a cross section thereof shown below, showing how the wiring-finished resin sheet insert-formed into a lens will appear.

### DESCRIPTION OF THE PREFERRED EMBODIMENTS

Embodiments of the invention will be described with reference to the accompanying drawings.

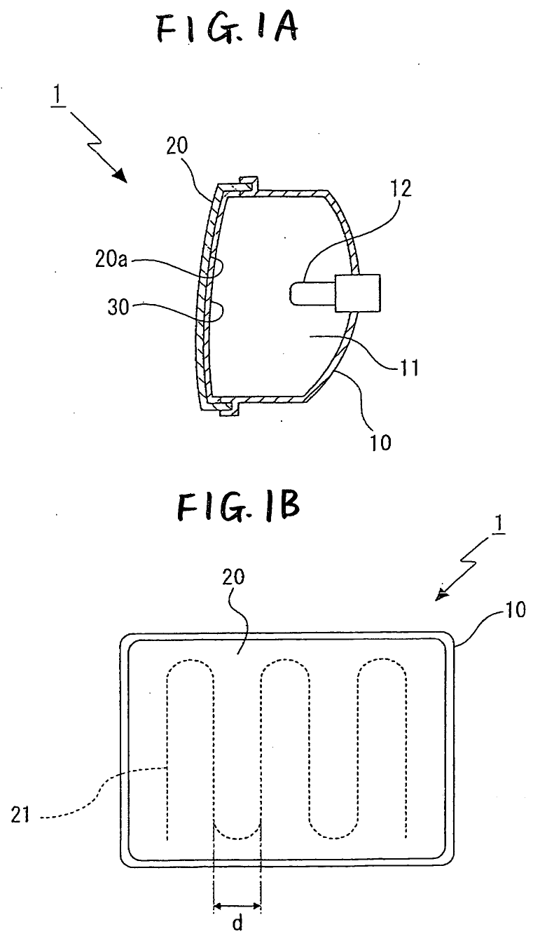

FIGS. 1A and 1B show an example of a vehicle lamp manufactured in accordance with one or more embodiments of the present invention.

A vehicle lamp 1 is for example a headlamp for a vehicle. The front opening of a lamp body 10 having a concave section open in the forward direction is covered with a lens 20 so as to form a lamp room 11 defined by the lamp body 10 and the lens 20. In the lamp room 11 is arranged a light source bulb 12. The light source bulb 12 is for example a discharge bulb although it may be a light source bulb other than a discharge bulb, for example a light bulb or a light-emitting diode.

Inside the lens 20 are fixed metal wires 21 that emit heat by energization, for example copper wires. The diameter of the metal wire 21 is preferably 0.05 mm to 0.2 mm and a distance d between adjacent metal wires is preferably 5 mm to 25 mm. In case the diameter of the metal wire 21 is too small, the wire is likely to be broken. In case it is too large, the wire shields light passing through the lens, which has an adverse effect on light distribution and causes the metal wire 21 to be too conspicuous to be good-looking. In case the distance d between wires is too small, the adverse effect on light distribution increases. Conversely, in case the distance d is too large, a desired amount of heat is not obtained.

In the vehicle lamp 1, when the metal wire 21 connected to the lens 20 is energized, the metal wire 21 is heated. This elevates the temperature at the section of the lens 20 where the metal wire 21 is laid, which melts the snow stuck to the surface of the lens 20 and removes fog inside and outside the lens 20.

Next, a measure to lay the metal wire 21 into the internal of the lens 20 and fix the laid metal wire 21 to the lens 20 will be described.

The metal wire 21 is laid on the resin sheet 30 via thermally wiring. The material resin of the resin sheet 30 is preferably the same as the material resin of the lens 20, for example a polycarbonate resin or an acrylic resin. The metal wire 21 is laid on such a resin sheet 30 via thermally wiring. Thermally wiring refers to a process of heating a base material to receive the metal wire 21 (the resin sheet 30 in this example) to soften the sheet by heat and applying the metal wire 21 to a softened section of the base material in order to embed the metal wire 21 at least partially. Methods for heating the base material include giving an ultrasonic vibration to the base material and pressing the heated member onto the base material.

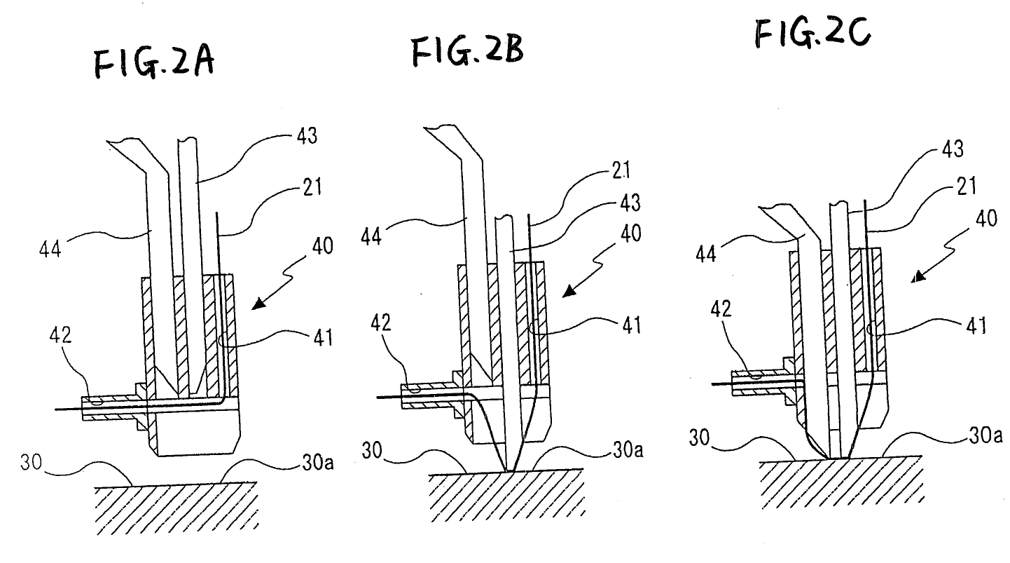

A numeral 40 in FIG. 2A denotes a wiring head for thermally wiring. In the state shown in FIG. 2A, the metal wire 21 is inserted into a guide part 41, 42 so as to draw a substantially L-shaped path. From the state shown in FIG. 2A, a wiring foot 43 is protruded as shown in FIG. 2B. This causes the metal wire 21 to be pulled by the tip of the wiring foot 43 and further drawn from the guide part 41, thus forming a V-shaped area in the L-shaped horizontal part. Then, the tip of the wiring foot 43 is pressed onto a base material (resin sheet 30). This keeps the tip of the V-shaped part of the metal wire 21 pressed against the resin sheet 30. Then, the tip of the wiring foot 43 is heated or an ultrasonic vibration is given to the wiring foot 43, which heats to soften the part of resin sheet 30 in contact with the wiring foot 43 (directly or via the metal wire 21). In this way, as long as an appropriate pressure is applied to wiring foot 43 against the resin sheet 30, the metal wire 21 is pressed by the wiring foot 43 and inserted into the resin sheet 30 already softened by heat (refer to FIG. 6).

When the wiring head is moved in a desired path with an appropriate pressure applied toward the resin sheet 30 while the wiring foot 43 is heated or an ultrasonic vibration is applied, the metal wire 21 is embedded into the resin sheet 30 along the above path.

When the wiring head 40 has traveled to the end of the wiring area, the tip of a cutter 44 is protruded as shown in FIG. 2C to break the metal wire 21.

When the wiring of the metal wire 21 into the resin sheet 30 is complete, both ends of the metal wire 21 are connected to a terminal 22 previously connected to the resin sheet 30. Connection of the metal wire 21 to the terminal 22 is fixed by way of post-welding where the end of the metal wire 21 is wound onto the terminal 22.

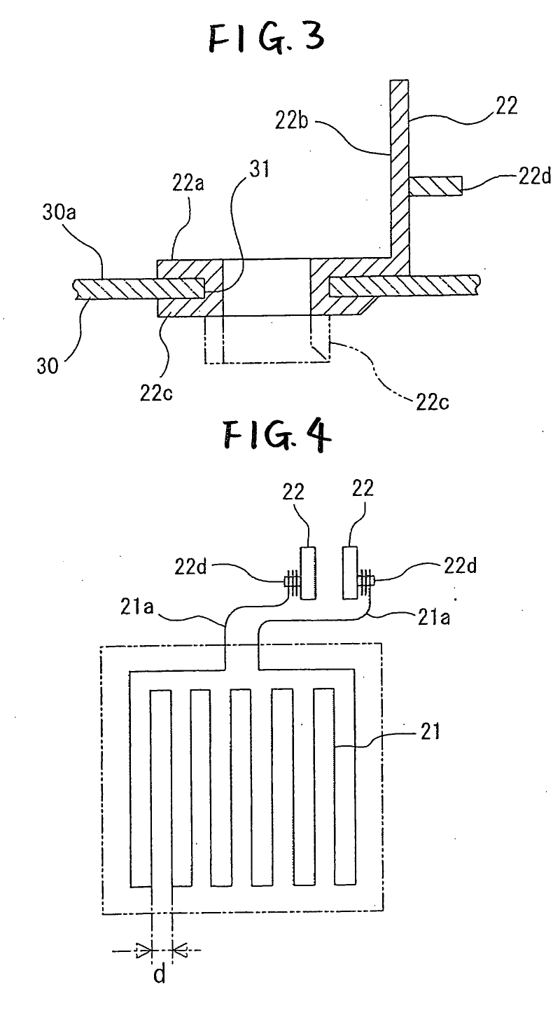

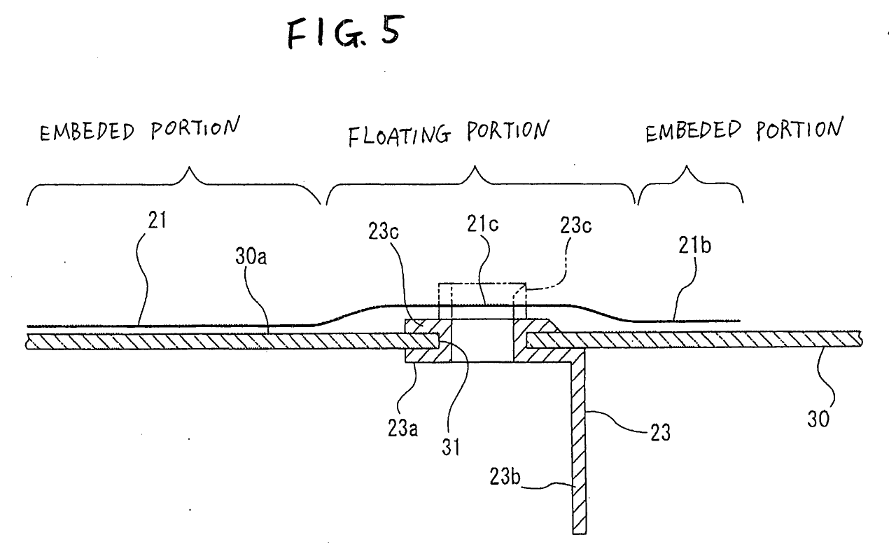

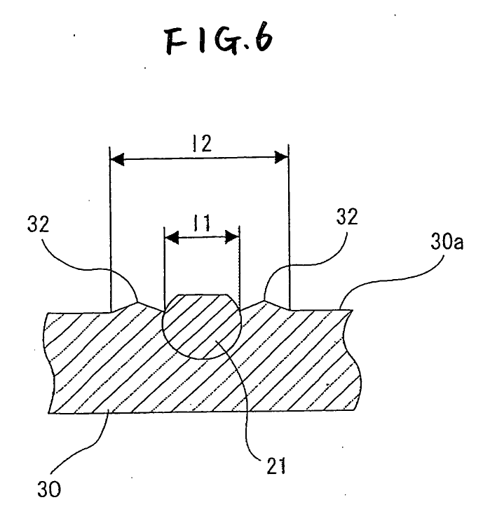

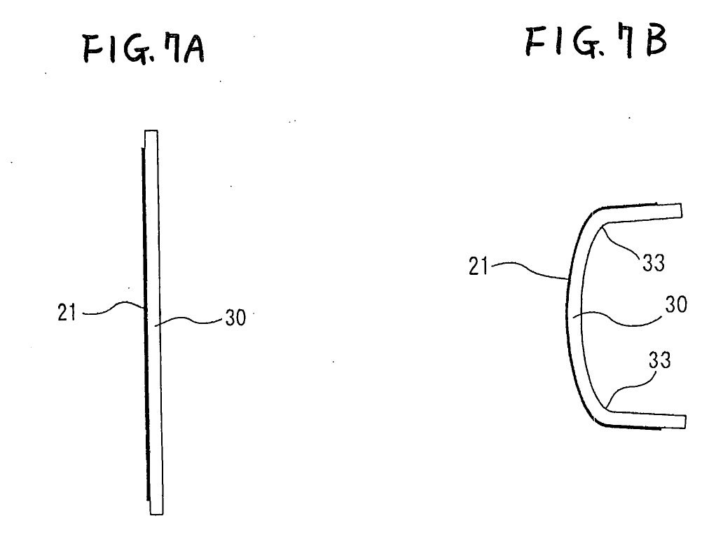

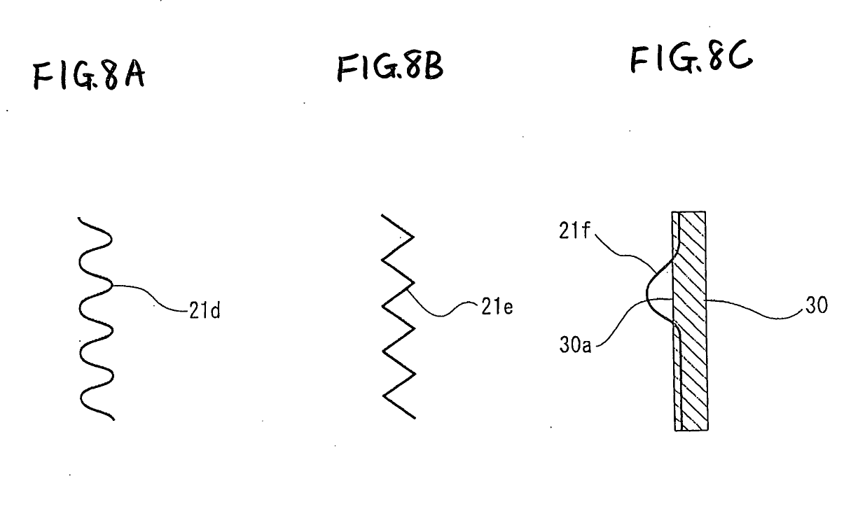

The terminal 22 has a connection part 22b protruding from the end of one surface of a flat base 22a and a barrel part 22c protruding from the other surface of the base 22a. Onto the connection part 22b is extending a protrusion 22d for winding. The barrel part 22c of the terminal 22 is inserted into a mounting hole 31 formed in the resin sheet 30 (refer to chain double-dashed lines in FIG. 3), and the barrel part is crimped (refer to solid lines in FIG. 3) so as to bend outward the part passing out of the rear surface of the resin sheet 30. In doing so, the terminal 22 is fixed to the resin sheet 30. The end of the metal wire 21 laid onto the resin sheet 30 is wound and welded onto the protrusion 22d extending from the connection part 22b of the terminal 22.

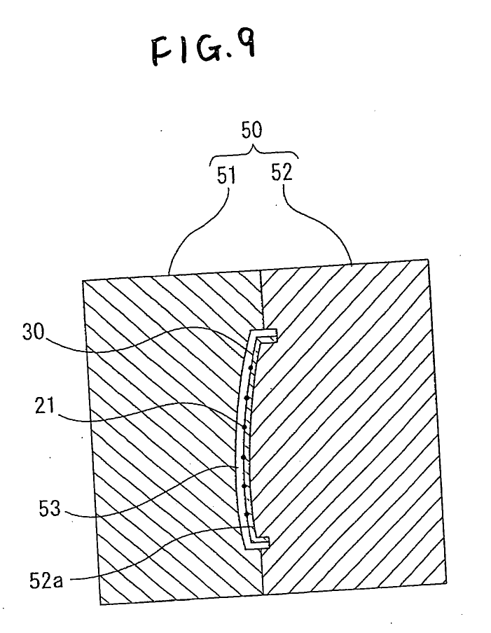

While the outline of the wiring pattern is shown in FIG. 4, for example, the metal wire 21 is embedded into the resin sheet 31 in an area enclosed by chain double-dashed lines and the metal wires 21a, 21a positioned outside the area enclosed by chain double-dashed lines are placed away (floating) from the resin sheet 30, and the ends of the parts 21a, 21a are wound and welded onto the protrusions 22d, 22d of the terminals 22, 22.

FIG. 5 shows another example of connection of the metal wire 21 laid onto the resin sheet 30 and the terminal. The terminal 23 has a connection part 23b protruding from the end of one surface of a flat base 23a and a barrel part 23c protruding from the other surface of the base 23a. The barrel part 22c of the terminal 22 is inserted into a mounting hole 31 formed in the resin sheet 30 (refer to chain double-dashed lines in FIG. 5), and the barrel part is crimped (refer to solid lines in FIG. 5) so as to bend outward the part passing out of the rear surface of the resin sheet 30. In doing so, the terminal 23 is fixed to the resin sheet 30.

The metal wire 21 embedded into the resin sheet 30 up to a section close to the base 22a of the terminal 23 is placed away (floating) from the resin sheet 30, and the metal wire 21 is made to stride onto the base 23a. Where the metal wire 21 strides onto the base 23a, the end 21b is embedded into the resin sheet 30. The part 21c of the metal wire 21 that strides onto the base 232a of the terminal 23 is welded to the base 23a of the terminal 23.

In this way, the metal wire 21 is laid into the resin sheet 30 in a desired pattern. The terminals 22, 22 (or 23, 23) are connected to the ends of the metal wire 21. In the state where the metal wire 21 is embedded into the resin sheet 30 by way of thermally wiring, the metal wire 21 is embedded into the resin sheet 30 only halfway as shown in FIG. 6. Moreover, the resin material pushed away by the embedded metal wire 21 presents a bank-like prominence along the metal wire 21. An end-to-end width 12 of the bank-shaped prominence 32, 32 is naturally larger than the diameter of the metal wire 21, which impairs the appearance of the resin sheet 30. The bank-shaped prominence 32, 32 functions as a prism for incoming light, so that irregular deflection around the bank-shaped prominence 32, 32 disturbs light distribution.

Next, as mentioned above, the lens 20 is projection molded while the resin sheet 30 into which the metal wire 21 is embedded is inserted into a mold. Before this process, pre-forming is preferably made to the metal wire 30 into a predetermined shape. The pre-forming process facilitates insertion of the resin sheet 30 into the mold. The pre-forming is made by way of so-called thermoforming that heats to soften the resin sheet 30 and presses it onto a mold by way of suction using vacuum, presses the resin sheet 30 onto the mold by way of air pressure of compressed air, or compress the resin sheet 30 between two molds. For example, the plate-shaped resin sheet 30 shown in FIG. 7A is formed into a curved surface shown in FIG. 7B via thermoforming. In this practice, the metal wire 21 is positioned at the side in contact with the material resin of the lens 20. When the resin sheet is formed from the shape shown in FIG. 7A to that in FIG. 7B, the metal wire 21 is positioned outside, so that the metal wire 21 is expanded. In particular, at corners 33, 33 that bend with a sharp curvature, the metal wire 21 is expanded to a large extent. This could result in a wire break.

It is useful to give a margin to the metal wire 21 positioned at a section that could be expanded to a large extent in pre-forming. FIGS. 8A to 8C show some examples of the margin.

FIG. 8A shows a margin 21d formed with the metal wire 21 embedded into a waveform pattern. FIG. 8B shows a margin 21e formed with the metal wire 21 embedded into a zigzag pattern. FIG. 8C shows a margin 21f positioned while partially floating from the resin sheet 30. These margins 21d, 21e, 21f absorbs the elongation of the resin sheet 30 so that wire break of the metal wire 21 is unlikely to take place.

As mentioned above, the shaped resin sheet 30 is inserted into a mold 50 for forming the lens 20. As shown in FIG. 9, a fixed mold 51 and a movable mold 52 are clamped to form a cavity 53. The cavity 53 is formed into a size that matches the size of the lens 20 plus the size of the shaped resin sheet 30. The shaped resin sheet 30 is inserted into the cavity 53. In this practice, the resin sheet 30 is inserted in a direction where the surface 30a with the metal wire 21 embedded will be positioned opposite to the mold surface 52a.

Then, the material resin of the lens 20 is injected into the cavity 53 to mold the lens 20. Heat from the injected resin softens the wire-mounting surface 30a with which the injected resin has come into contact. The wire-mounting surface 30a of the resin sheet 30 and the portion of the injected resin sheet 30 that is in contact with the wire-mounting surface 30a of the resin sheet 30 are compatible with each other. The injected resin is cooled and solidified to integrate the lens 20 and the resin sheet 30. The lens 20 and the resin sheet 30 integrated to the same are taken out of the mold 50, thus forming the lens 20 with which a heater is integrated.

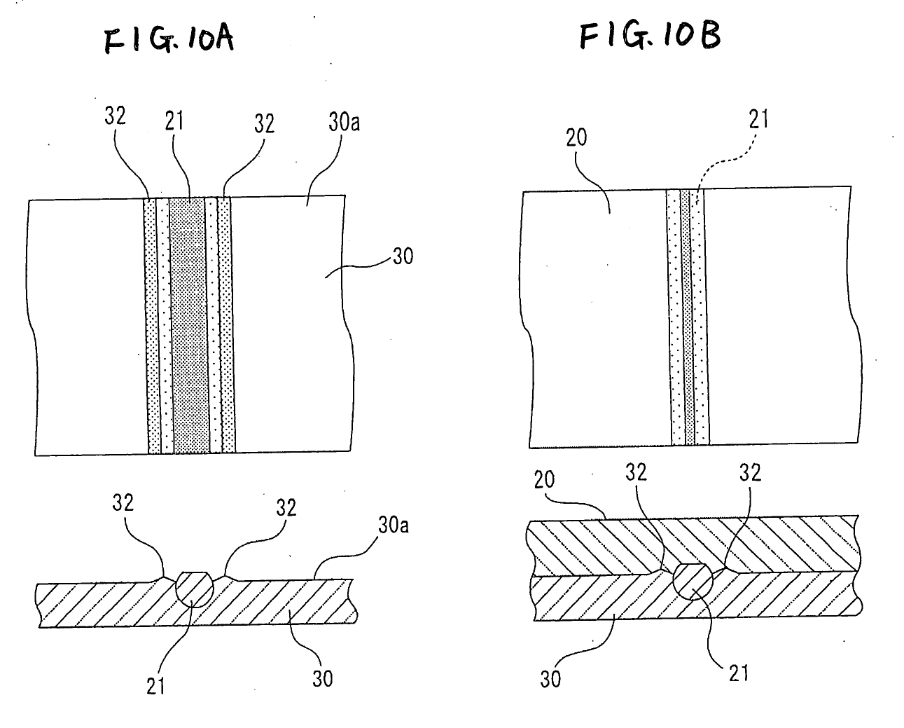

As mentioned above, in the state where the metal wire 21 is laid into the resin sheet 30, the bank-shaped prominence 32, 32 on both sides of the metal wire 21 is too conspicuous to be good-looking as shown in FIG. 10A. Once the lens 20 is integrated into the wire-mounting surface 30a of the resin sheet 30, the irregular deflection on the bank-shaped prominence 32, 32 is reduced to a substantially negligible level. Thus, as viewed from the lens 20, the metal wire 21 alone is conspicuous and the presence of the bank-shaped prominence 32, 32 is almost negligible as shown in FIG. 10B.

When the lens 20 is incorporated into the lamp body 10, the terminals 22, 22 or 23, 23 are connected via connectors to the power source in order to feed power to the metal wire 21 as appropriate.

According to the method for manufacturing a vehicle lamp, wiring of the metal wire 21 is made onto the resin sheet 30 that has only a two-dimensional stretch. This promises east wiring. Thermally wiring is employed so that the metal wire 21 is retained in the resin sheet 30 as soon as wiring is made. This eliminates the need for fixing means for fixing the wired metal wire 21 to the resin sheet 30, for example an adhesive. In this respect also, the wiring process is made with ease and at a low cost.

The resin sheet 30 to which thermally wiring is applied is not used as such, but the resulting resin sheet 30 is integrated into the lens 20 by way of so-called insert forming. Thus, the factors to disturb light distribution on the resin sheet 30 caused by thermally wiring is substantially coated by the material resin of the lens 20. The metal wire 21 is virtually the only factor to influence light distribution. Light distribution is scarcely influenced by disturbing factors as long as the thickness and mounting density of the metal wire 21 are properly selected.

In accordance with one or more embodiments of the present invention, it is easy to lay a metal wire into a lens of a vehicle lamp equipped with a fog removing feature and snow melting feature in cold districts, with good appearance and function of the finished lens.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A method for manufacturing a vehicle lamp, the method comprising:
thermally wiring a metal wire on a resin sheet; and
injection molding a lens with the resin sheet inserted in a mold.

2. The method according to claim 1, wherein the metal wire laid on the resin sheet is used as a heater.

3. The method according to claim 1, wherein the thermally wiring comprises ultrasonic wiring wherein an ultrasonic vibration is applied so that the resin sheet is heated and melted and the metal wire is partially embedded into the resin sheet.

4. The method according to claim 1, further comprising:
shaping the resin sheet into a predetermined profile before inserting the resin sheet into the mold.

5. The method according to claim 1, further comprising:
fixing a terminal on the resin sheet.

6. The method according to claim 5, further comprising:
positioning the metal wire so that the metal wire strides over the terminal; and
welding the terminal and the metal wire striding over the terminal.

7. The method according to claim 1, wherein the resin sheet is inserted into the mold so that a surface on which the metal wire is laid is faced to a resin to be injected.

8. A vehicle lamp made by a process comprising:
thermally wiring a metal wire on a resin sheet; and
injection molding a lens with the resin sheet inserted in a mold.

9. A vehicle lamp comprising:
a resin sheet;
a lens integrally formed on the resin sheet; and
a metal wire partially embedded into the resin sheet and disposed between the resin sheet and the lens.

10. The vehicle lamp according to claim 9, wherein the metal wire is used as a heater.

11. The vehicle lamp according to claim 9, further comprising:
a bank-shaped prominence on the resin sheet at a position on a side of the metal wire.

12. The vehicle lamp according to claim 9, wherein the resin sheet is inserted into the mold so that a surface on which the metal wire is laid is faced to a resin to be injected.
